(19) United States
(12) Patent Application Publication
(10) Pub. No.: US 2019/0223283 A1
(43) Pub. Date: Jul. 18, 2019

(54) Device For Generating High-Intense And Steady-State Neutrons

(71) Applicant: HEFEI INSTITUTES OF PHYSICAL SCIENCE, CAS, Anhui (CN)

(72) Inventors: Yican WU, Anhui (CN); Yongfeng WANG, Anhui (CN); Xiang JI, Anhui (CN); Zhumin ZHAO, Anhui (CN); Wen WANG, Anhui (CN)

(73) Assignee: HEFEI INSTITUTES OF PHYSICAL SCIENCE, CAS, Anhui (CN)

(21) Appl. No.: 16/243,268

(22) Filed: Jan. 9, 2019

(30) Foreign Application Priority Data
Jan. 12, 2018 (CN) 201810031055.7

(51) Int. Cl. H05H 3/06; G21B 3/00; H05H 6/00

(52) U.S. Cl. CPC H05H 3/06; H05H 6/00; G21B 3/006

(57) ABSTRACT

A device for continuously generating high intensity neutrons is provided. The device includes a differential vacuum system, a throttle pipe, a linear target tube and a solid target device arranged in sequence along a moving direction of a beam. The beam and a gaseous medium react in the linear target tube, and the beam and a solid medium react in the solid target device. Two ends of an inner cavity of the linear target tube are hermetically connected to the throttle pipe and a chamber of the solid target device, respectively.

### CROSS REFERENCE TO RELATED APPLICATION

The present application claims the priority to Chinese Patent Application No. 201810031055.7, titled “DEVICE FOR GENERATING HIGH-INTENSE AND STEADY-STATE NEUTRONS”, filed on Jan. 12, 2018 with the Chinese Patent Office, which is incorporated herein by reference in its entirety.

### FIELD

The present disclosure relates to the technical field of deuterium-tritium neutron sources, and particularly relates to a device for continuously generating high-intensity neutrons.

### BACKGROUND

An accelerator-based deuterium-tritium fusion neutron source bombards, by employing a high-intensity deuterium ion beam, a tritium target to cause the deuterium-tritium fusion reaction, so as to generate high-energy fusion neutrons of 14 MeV, which can be used in research fields such as neutron physics, nuclear medicine, radiation protection, and nuclear technology application.

A conventional deuterium-tritium fusion neutron source generally employs a solid target device, that is, deuterium or tritium is adsorbed in a film on the surface of a metal disc of the solid target device, and a deuterium beam is employed to bombard the target, to create deuterium-deuterium or deuterium-tritium fusion reactions. When a deuterium beam with certain energy bombards the surface of the solid target, the penetrating depth is only a few micrometers, and a point source of the beam spot size is generated. Therefore, a single solid target can only generate a point neutron source. While a linear neutron source can be generated by arranging a gaseous target basing on the following principles, i.e., the beam can penetrate a deeper depth (several meters) in a gaseous target since the energy attenuation and scattering of the beam are relatively small in gas with a relatively small density, and a linear source is generated along the path of the beam in the gas target. If a linear neutron source is to be generated, due to a relatively small density of gas molecules in a gaseous target, the collision received by the beam and the energy attenuation are relatively small, the beam can penetrate a deeper depth (several meters) in the gaseous target, and a linear source of a path that the beam passes through is generated, and thus a linear neutron source can be generated.

A high neutron intensity cannot be achieved either by a single conventional point neutron source or a single linear neutron source with gaseous target, due to too high heat flux density during the high-intensity beam depositing on the solid surface for a conventional point neutron source, or the challenge of beam transportation in the gaseous with the requested high pressure for a conventional linear neutron source with gaseous target. Therefore, the neutron source intensities which are achieved by a single line neutron source and a single point neutron source are limited.

In addition, separate devices are required to generate a linear neutron source and a point neutron source respectively, thus the operation is complicated.

Therefore, the issue of how to generate a neutron source with high-intensity by a linear neutron source, a point neutron source, or a combination thereof needs to be urgently addressed in this field.

### SUMMARY

A device for continuously generating high intensity neutrons is provided according to the present disclosure, to generate a linear neutron source and a point neutron source simultaneously.

In order to achieve the above object, a device for continuously generating high-intensity neutrons is provided according to the present disclosure, which includes a differential vacuum system, a throttle pipe, a linear target tube and a solid target device arranged in sequence along a moving direction of a beam. The beam and a gaseous medium react in the linear target tube, the beam and a solid medium react in the solid target device, and two ends of an inner cavity of the linear target tube are hermetically connected to the throttle pipe and a chamber of the solid target device, respectively.

In an embodiment, the differential vacuum system includes a mechanical pump, an exhaust pipe and exhaust chambers in communication with the exhaust pipe. The number of the exhaust chambers is at least two. Each of the exhaust chambers is connected to at least one vacuum pump assembly, and gas outlet ends of multiple vacuum pump assemblies are connected to a gas inlet end of the mechanical pump.

In an embodiment, the differential vacuum system further includes a purification device mounted at an outlet end of the mechanical pump, an outlet end of the purification device is in communication with the chamber of the solid target device through a gas delivery pipe. The vacuum pump assembly includes a roots pump, a molecular pump, a molecular booster pump and a low-temperature pump connected in sequence along a gas flowing direction.

In an embodiment, the solid target device includes a housing, a solid target, a magnetic fluid dynamic sealing component, a transmission shaft and a rotor driving device for driving the transmission shaft to move. The solid target is arranged in the housing, the chamber is formed between an outer side of the solid target and the housing, and the transmission shaft is fixedly connected to the solid target. The magnetic fluid dynamic sealing component includes a magnetic fluid dynamic sealing inner shell coaxially fitted with an outside surface of the transmission shaft and a magnetic fluid dynamic sealing outer shell arranged coaxially with the solid target and detachably connected to the housing, and the magnetic fluid dynamic sealing outer shell covers the magnetic fluid dynamic sealing inner shell. The housing is mounted at a tail end of the linear target tube in the moving direction of the beam, and an axis of the linear target tube directly faces the solid target.

In an embodiment, a distance between the tail end of the linear target tube in the moving direction of the beam and a rotation center of the solid target is greater than zero, in a projection in a direction of a rotation axis of the solid target.

In an embodiment, the solid target includes a target outer shell, a copper disc and a chassis. The target outer shell and the copper disc each are fixedly connected to the chassis. The copper disc and the target outer shell constitute an inner cavity to form a liquid coolant flowing cavity, a front surface of the copper disc directly faces the tail end of the linear target tube along the moving direction, and a titanium film is deposited on the front surface of the copper disc. The chassis is arranged inside the cavity of liquid coolant and between the target outer shell and the copper disc, and the chassis is fixedly connected to the transmission shaft.

In an embodiment, a back surface of the copper disc being away from the front surface, is provided with water inlet grooves radially and uniformly distributed in a radial direction. A liquid inlet of each of the water inlet grooves is a central hole of the copper disc, a liquid outlet of each of the water inlet grooves is located at a position in an inner ring of an annular band where the beam bombards the copper disc. A side of the chassis opposite to the back surface, is provided with an annular jet ring. An outer end of the annular jet ring is hermetically connected to an outer end of the chassis, an outer end face of an inner end of the annular jet ring is provided with a supporting projection hermetically connected to the back surface. The annular jet ring is provided with multiple jet holes centered at a rotation axis of the copper disc and uniformly distributed in a circumferential direction, outlet ends of the jet holes directly face the back surface of the copper disc, and the annually arranged jet holes directly face the annular band where the beam bombards the copper disc. The back surface of the chassis, which is arranged away from the copper disc is provided with backwater grooves radially and uniformly distributed in the radial direction. The liquid inlet end of each of the backwater grooves is located at an outer edge of the chassis, a liquid inlet cavity is formed between the copper disc and the chassis, and a liquid return cavity is formed between the chassis and the target outer shell. The liquid inlet cavity is in communication with the liquid return cavity through the jet holes.

In an embodiment, the device further includes a solid target cooling device. The solid target cooling device includes a first water pipe and a second water pipe sleeved on an outer side of the first water pipe. A cavity between the first water pipe and the second water pipe is connected to the liquid inlet cavity, an inner cavity of the first water pipe is connected to the liquid return cavity, and the first and second water pipes constitute the transmission shaft.

In an embodiment, a central hole convex flange of the chassis is attached to an end face of the first water pipe, and a threaded hole is provided at an end of an outer side convex flange of the chassis to be connected to an end face of the second water pipe through threaded connection. An external thread is formed on an outer wall of the outer side convex flange of the chassis to be connected to and cooperate with an internal thread on an inner wall of a central hole of the copper disc. A cylinder wall of the outer side convex flange of the chassis is provided with holes, and the holes are in communication with the water inlet grooves.

In an embodiment, the linear target tube includes an electromagnet, a first target tube and a second target tube sleeved on an outer side of the first target tube. A flowing coolant is provided between the first and second target tubes. The electromagnet is mounted at an outer side of the second target tube. Both the first and second target tubes are elastic corrugated tubes that are retractable in the axial direction.

In the above technical solutions, a device for continuously generating high intensity neutrons is provided according to the present application, which includes a differential vacuum system, a throttle pipe, a linear target tube and a solid target device arranged in sequence in a moving direction of a beam. The beam and a gaseous medium react in the linear target tube, and the beam and a solid medium react in the solid target device. Two ends of an inner cavity of the linear target tube are hermetically connected to the throttle pipe and a chamber of the solid target device, respectively. In a case that the linear neutron source is to be generated, an inlet end of the differential vacuum system is connected to a tail end of an accelerator, with the intense beam passing through the differential vacuum system and the throttle pipe to enter the linear target tube, and the linear target tube is filled with a reactive gas, deuterium or tritium, having a maximum pressure of 10000 Pa. The beam performs a deuterium-deuterium reaction or a deuterium-tritium reaction with gaseous deuterium and tritium in the linear target tube, to generate the neutron. When a deuterium beam passes through the linear target tube, collisions and energy attenuation are relatively small and the beam can transmit for a relatively long distance, since gaseous deuterium or tritium has a small density. When the beam continues to transmit to the chamber of the solid target device, the beam bombards the solid target, and continues to react with deuterium or tritium adsorbed on a surface of the solid target, to generate the neutron.

It can be seen from the above description that, the device for continuously generating high-intensity neutrons is provided according to the present application. In which, the solid target device is arranged behind the linear gaseous target tube, to generate neutrons as a point neutron source. In addition, the differential vacuum system is arranged to realize the linear target tube separation, so that the neutrons with high source intensity can be stably generated by the linear neutron source and the point neutron source.

### BRIEF DESCRIPTION OF THE DRAWINGS

For more clearly illustrating technical solutions in embodiments of the present disclosure or in the conventional technology, drawings to be used in the description of the embodiments or the conventional technology are briefly described hereinafter. Apparently, the drawings in the following descriptions show only example embodiments of the present disclosure, and for those skilled in the art, other drawings may be obtained based on these drawings without any creative efforts.

FIG. 1 is a schematic structural view of a device for continuously generating high intensity neutrons according to an embodiment of the present disclosure;

FIG. 2 is a schematic structural view showing a sectional view according to an embodiment of the present disclosure;

FIG. 3 is a schematic view showing an operating principle of a device for continuously generating high-intensity neutrons according to an embodiment of the present disclosure;

FIG. 4 is a schematic structural view of a solid target device according to an embodiment of the present disclosure;

FIG. 5 is a partial sectional view of a solid target according to an embodiment of the present disclosure; and

FIG. 6 is an exploded view of a solid target according to an embodiment of the present disclosure.

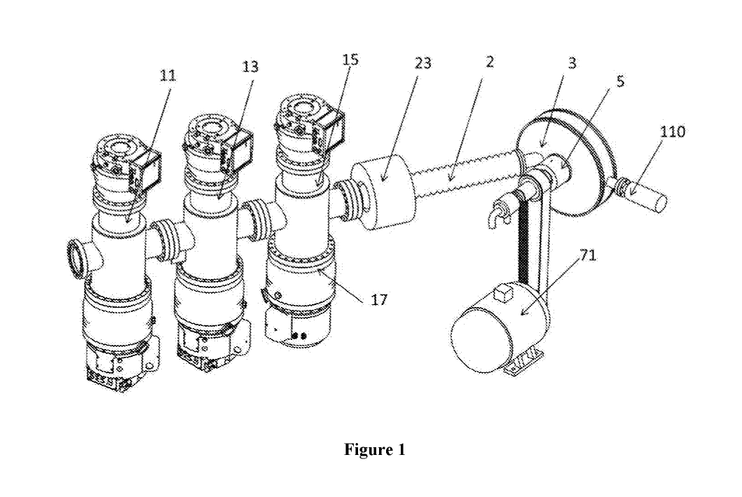

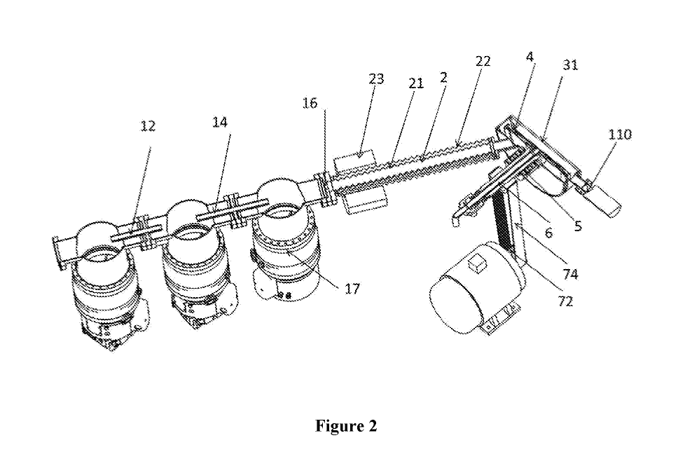

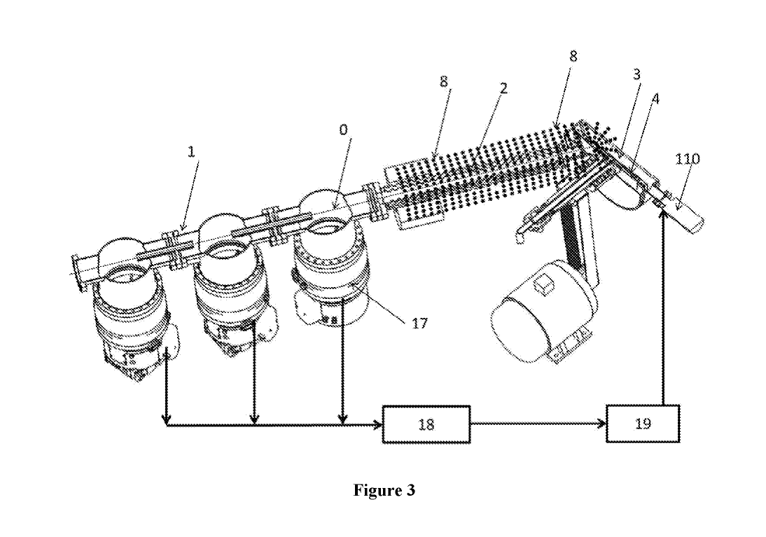

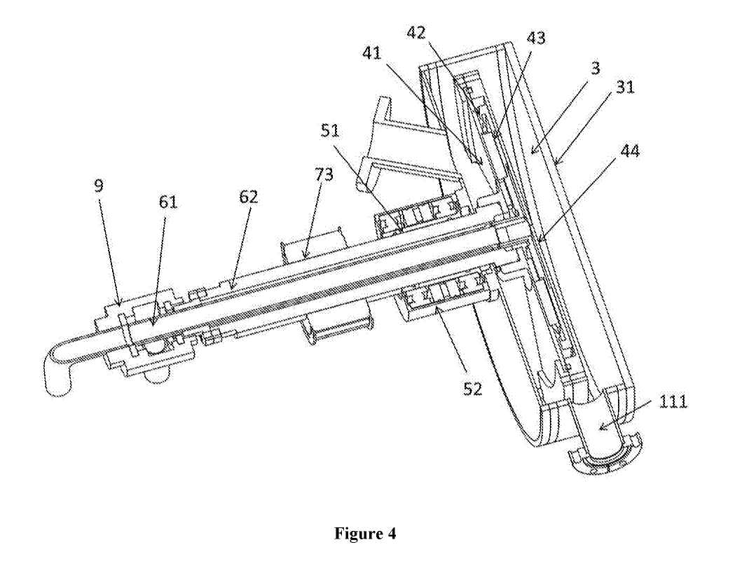

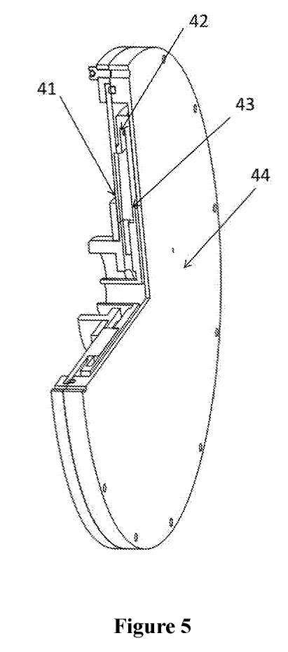

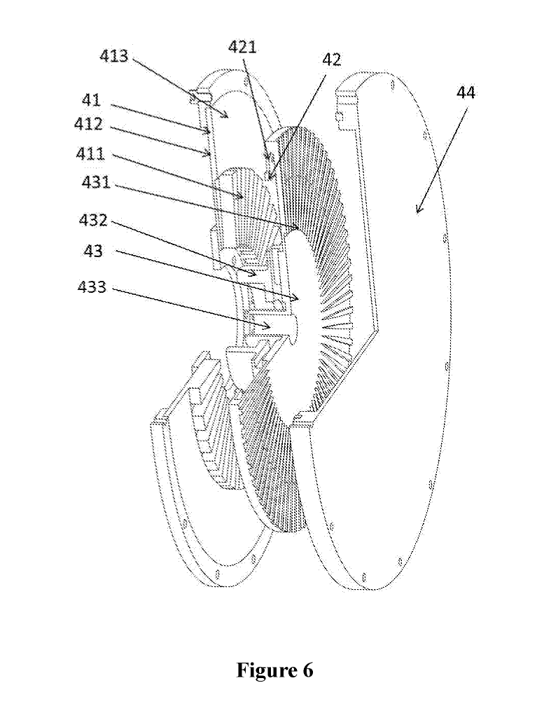

### REFERENCE NUMERALS IN FIGS. 1 TO 6

| | | | |
|---|---|---|---|
| 0 | beam, | 1 | differential vacuum |
| | | | system, |
| 11 | third-stage exhaust chamber, | 110 | inlet gas valve, |
| 111 | gas inlet, | 12 | third-stage pipe, |
| 13 | second-stage exhaust chamber, | 14 | second-stage pipe, |
| 15 | first-stage exhaust chamber, | 16 | throttle pipe, |
| 17 | vacuum pump assembly, | 18 | mechanical pump, |
| 19 | purification device, | 2 | linear target tube, |
| 21 | first target tube, | 22 | second target tube, |
| 23 | electromagnet, | 3 | chamber, |
| 31 | housing, | 4 | solid target, |
| 41 | copper disc, | 411 | water inlet groove, |
| 412 | front surface, | 413 | back surface, |
| 42 | annular jet ring, | 421 | jet hole, |
| 43 | chassis, | 431 | backwater groove, |
| 432 | outer side convex flange, | 433 | central hole, |
| 44 | target outer shell, | | |
| 5 | magnetic fluid dynamic sealing | | |
| | component, | | |
| 51 | magnetic fluid dynamic sealing | | |
| | inner shell, | | |
| 52 | magnetic fluid dynamic sealing | | |
| | outer shell, | | |
| 6 | transmission shaft, | 61 | first water pipe, |
| 62 | second water pipe, | 71 | motor, |
| 72 | driving pulley, | 73 | driven pulley, |
| 74 | synchronous belt, | 8 | neutrons, |
| 9 | rotating joint, | | |

### DETAIL DESCRIPTION

According to the present disclosure, a device for continuously generating high-intensity neutrons is provided, to generate neutrons as a linear neutron source and a point neutron source simultaneously.

In order to enable those skilled in the art to better understand technical solutions of the present disclosure, the present disclosure will be further described in detail in conjunction with drawings and embodiments hereinafter.

Reference is made to FIGS. 1 to 6. In a specific embodiment, a device for continuously generating high-intensity neutrons provided according to an embodiment of the present disclosure includes a differential vacuum system 1, a throttle pipe 16, a linear target tube 2 and a solid target device arranged in sequence in a moving direction of a beam 0. The beam 0 and a gaseous medium react in the linear target tube 2, and the beam 0 and a solid medium react in the solid target device. Two ends of an inner cavity of the linear target tube 2 are hermetically connected to the throttle pipe 16 and a chamber 3 of the solid target device respectively. Specifically, in order to improve security level, the solid target device is fixedly connected to the linear target tube 2, and the chamber 3 may be cylinder-shaped or other suitable shapes. A gas inlet 111 is provided at a suitable position, not in an incident direction of the beam 0 and being away from a bombardment point of the beam 0, in the chamber 3. A gas inlet valve 110 is mounted to allow a reactive gas to enter in real time. The beam 0 and gaseous tritium or deuterium react inside the linear target tube 2, and the beam 0 and solid tritium or deuterium react on a surface of the solid target 4 in the solid target device.

In a transmission direction of the beam 0, the beam 0 first reacts with tritium or deuterium gas inside the linear target tube, and then reacts with tritium or deuterium adsorbed in the solid target. The beam 0 is a beam of deuterium, tritium or mixed deuterium-tritium, and the surface of the solid target 4 is adsorbed with deuterium, tritium or mixed deuterium-tritium. Accordingly, a deuterium-deuterium reaction or a deuterium-tritium reaction occurs inside the linear target tube 2 and on the surface of the solid target 4. The solid target 4 is coupled to the beams 0 with different energy to rotate or to be fixed. The solid target 4 should be static when the energy of beam 0 is low and rotary when the energy of beam 0 is high. Specifically, the beam 0 may fixedly impact a point on the surface of the solid target 4 or bombard an annular band region on the surface of the solid target 4.

In a case that neutrons are to be generated by the linear neutron source, a gas inlet end of the differential vacuum system 1 is connected to a tail end of an accelerator, and an intense beam 0 passes through the differential vacuum system 1 and the throttle pipe 16 to enter the linear target tube 2. The linear target tube 2 is filled with the reaction gas, deuterium or tritium, having a maximum pressure of 10000 Pa. The beam 0 performs a deuterium-deuterium reaction or a deuterium-tritium reaction with gaseous deuterium and tritium in the linear target tube 2, to generate neutrons as a linear neutron source. When the deuterium beam passes through the linear target tube 2, the collision and energy attenuation are relatively small and the beam 0 can transmit for a relatively long distance, since the density of deuterium or tritium gas is a rather small. When the beam 0 continues to transmit to the chamber 3 of the solid target device, the beam 0 bombards the solid target 4, and continues to react with deuterium or tritium adsorbed on the surface of the solid target 4, to generate neutrons as a point neutron source. That is, the device for continuously generating high-intensity neutrons is mounted at a tail end of a neutron source accelerator, so that the neutrons with high-intensity are generated from a linear neutron source and a point neutron source simultaneously, and deuterium-tritium (DT) neutrons with an energy about 14.1 MeV and deuterium-deuterium (DD) neutrons with an energy about 2.5 MeV, which have a maximum neutron intensity of 10¹⁵ n/s, can be generated.

It can be seen from the above descriptions that, in the device for continuously generating high-intensity neutrons provided according to the embodiment of the present disclosure, the reactive gas enters the linear target tube 2 and the chamber 3 through the gas inlet 111, a gas pressure is monitored in real time. The gas, flowing toward the accelerator under the differential pressure, is throttled when passing through the throttle pipe 16, and pumped out by the differential vacuum system 1, so that the gas pressures in the accelerator, the linear target tube 2 and the solid target device are maintained stable. According to the present disclosure, the linear neutron source and the point neutron source can be generated simultaneously, and the neutron source intensity can be significantly increased under the beam 0 with the same flow intensity. The present disclosure can be applied to experiments with different neutron source energy distribution requirements at the same time, so that the line neutron source and point neutron source with a high neutron source intensity can be stably generated.

Preferably, the differential vacuum system 1 includes a mechanical pump 18, an exhaust pipe and an exhaust chamber in communication with the exhaust pipe. The number of the extraction chambers is at least two. Each of the exhaust chambers is connected to at least one vacuum pump assembly 17, and gas outlet ends of multiple vacuum pump assemblies 17 are connected to a gas inlet end of the mechanical pump 18. Specifically, the number of the exhaust chambers may be two. In order to improve a vacuuming effect, preferably, there are three exhaust chambers, which respectively are a third-stage exhaust chamber 11, a second-stage exhaust chamber 13 and a first-stage exhaust chamber 15 arranged in sequence in the beam 0 direction. The extraction pipes include a third-stage pipe 12 connecting the third-stage exhaust chamber 11 and the second-stage exhaust chamber 13, a second-stage pipe 14 connecting the second-stage exhaust chamber 13 and the first-stage exhaust chamber 15, and the throttle pipe 16 connecting an gas outlet end of the first-stage exhaust chamber 15 and an gas inlet end of the linear target tube 2. In order to improve the sealing performance, preferably, one end of the third-stage pipe 12 is arranged inside the third-stage exhaust chamber 11, and one end of the second-stage pipe 14 is arranged inside the second-stage exhaust chamber 13. The energy of the beam 0 for deuterium-tritium fusion neutron source is generally 100-600 keV. In a device where gaseous deuterium-tritium or deuterium-deuterium are to react, due to the contradiction between a high vacuum environment in the accelerator and a high pressure environment in the reaction region, certain devices are required in the transmission path of the beam 0 to prevent the gas in the reaction region from entering the accelerator. In the present disclosure, the device is implemented as the throttle pipe 16 including multi-stage throttle channels and micro-holes. That is, the differential vacuum system 1 achieves the pressure transition by employing a throttle hole or the throttle pipe 16. when the gas flowing through the pipe (or the micro-holes) in the throttle pipe 16 of which the pressure at two sides are P₁ and P₂, respectively. The relationship between the flow rate Q and the differential pressure can be described as:

Q=C(P₂−P₁)

where Q indicates a gas flow rate passing through the pipe; C indicates a flow conductance of the pipe; and P₂ and P₁ indicate an inlet pressure and an outlet pressure of the pipe, respectively.

The small flow conductance of the pipe and the micro-holes is used to limit the flow rate of the gas flowing from a high pressure section to a low pressure section, thereby reducing the pressure of the next stage. At the same time, the gas is exhausted from each of the exhaust chambers, to reduce the pressure stage by stage, and maintaining the differential pressure.

Preferably, the vacuum pump assembly includes a roots pump, a molecular pump, a molecular booster pump and a low-temperature pump connected in sequence along the gas flowing direction. The gas in the linear target tube 2 flows to the first-stage exhaust chamber 15 under the differential pressure, and the flow conductance of the throttle pipe 16 with a diameter of 5 mm to 30 mm is only 100 L/s. The pressure in the first-stage exhaust chamber 15 can be maintained at a level of dozens Pa, with a pumping speed greater than 2500 L/s of the vacuum pump equipped for the first-stage exhaust chamber 15. By analogy, the pressures of the second-stage exhaust chamber 13 and the third-stage exhaust chamber 11 can reach the level of 0.01 Pa to 0.0001 Pa, and this vacuum level meets the pressure requirement at junctions of the exhaust chambers and the accelerator.

More preferably, the differential vacuum system 1 further includes a purification device 19 mounted at an outlet end of the mechanical pump 18, and the outlet end of the purification device 19 is in communication with the chamber 3 of the solid target device through a gas delivery pipe. Specifically, the gas inlet valve 110 of the solid target device is in communication with the gas delivery pipe. The gas exhausted by the vacuum pump assembly 17 is pumped into the purification device 19 by the mechanical pump 18 of a preceding stage, and the reactive gas filtered, purified, and separated by the purification device 19 enters the target again through the gas inlet 111 of the chamber 3, to realize the recycling of the reactive gas. The gas exhausted by the vacuum pump assembly 17 enters the mechanical pump 18, then enters the purification device 19, and after being separated, purified, cleaned and proportioned by the purification device 19, the reactive gas having a purity higher than 99.99% enters the chamber 3 through the gas inlet valve.

In the present disclosure, the flow rate of the gas flowing from the mechanical pump 18 to the purification device 19 and flowing from the purification device 19 to the chamber 3 through the gas inlet valve 110 is the same as the flow rate of the gas flowing from the linear target tube 2 to the first-stage exhaust chamber 15, which can reach a maximum value of 560 slm (Standard Liter per Minute).

Further, the solid target 4 rotates in the chamber 3. The solid target device is configured to prevent a reactive gas leakage, and includes a housing 31, a solid target 4, a component of magnetic fluid dynamic sealing 5, a transmission shaft 6 and a rotor driving device for driving the transmission shaft 6 to move. The solid target 4 is arranged in the housing 31, the chamber 3 is formed between an outer side of the solid target 4 and the housing 31, and the transmission shaft 6 is fixedly connected to the solid target 4. The component of magnetic fluid dynamic sealing 5 includes a magnetic fluid dynamic sealing inner shell 51 coaxially fitted with an outer diameter of the transmission shaft 6, and a magnetic fluid dynamic sealing outer shell 52 arranged coaxially with the solid target 4 and detachably connected to the housing. The magnetic fluid dynamic sealing outer shell 52 covers an outer side of the magnetic fluid dynamic sealing inner shell 51. The housing 31 is mounted at a tail end of the linear target tube 2 in the moving direction of the beam 0, and the linear target tube 2 directly faces the solid target 4. Preferably, the rotor driving device includes a motor 71, a driving pulley 72 and a driven pulley 73 connected to the driving pulley 72 through a synchronous belt 74. The driving pulley 72 is coaxially mounted and fixed to an output shaft of the motor 71, which is fixed on a mounting base, and its axis is parallel to the transmission shaft 6. The driven pulley 73 meshes with the driving pulley 72 through the synchronous belt 74. An outer diameter of the transmission shaft 6 is coaxially fitted with the driven pulley 73. The motor 71 drives the driving pulley 72, and further drives the driven pulley 73 through the synchronous belt 74, thus the transmission shaft 6 and the solid target 4 are driven to rotate at a high speed. The motor 71 may be started or stopped.

The magnetic fluid dynamic sealing component 5 is located between the driven pulley 73 and the chamber 3. Specifically, the magnetic fluid dynamic sealing inner shell 51 is coaxially interference fitted with the outer diameter of the transmission shaft 6. The magnetic fluid dynamic sealing outer shell 52 is coaxial with the magnetic fluid dynamic sealing inner shell 51. The magnetic fluid dynamic sealing inner shell 51 rotates at a high speed together with the transmission shaft 6 and the solid target 4, and the magnetic fluid dynamic sealing outer shell 52 and the housing stay still. The magnetic fluid dynamic sealing component 5 can ensure the dynamic sealing and gas isolation between the chamber 3 and an outside during the rotation of the solid target 4.

Preferably, in a projection in a direction of a rotation axis of the solid target 4, a distance between the tail end of the linear target tube 2 in the moving direction of the beam 0, and a rotation center of the solid target 4 is greater than zero. That is, a mounting hole connected to the gas outlet end of the linear target tube 2 is provided at a decentration position in the chamber 3. The mounting hole is circular-shaped or square-shaped, and threaded holes are uniformly distributed around the mounting hole. The linear target tube 2 is circular-shaped or square-shaped, and an end flange of the linear target tube 2 is uniformly distributed with holes. The end flange of the linear target tube 2 and the mounting hole are fixed together through threaded fitting. The solid target 4 is driven by the rotor driving device with at a high rotating speed, the beam 0 bombards a decentration position of the solid target 4, an annular band is heated instead of a situation of continuous local heating, thereby improving a heat transfer effect, in order to prevent the adsorbed reactive gas, deuterium or tritium from being released, resulting in a temperature increase of the solid target 4 under constant bombardment of the beam 0 on the solid target.

More preferably, the solid target 4 includes a target outer shell 44, a copper disc 41 and a chassis 43. The target outer shell 44 and the copper disc 41 each are fixedly hermetically connected to the chassis 43. The copper disc 41 and the target outer shell 44 constitute an inner cavity to form a liquid coolant flowing cavity. The front surface 412 of the copper disc 41 directly faces the tail end of the linear target tube 2 in the moving direction of the beam 0. A titanium film is deposited on the front surface 412 of the copper disc 41, and the titanium film adsorbs deuterium and tritium. The maximum ratio of deuterium or tritium to titanium atoms in the titanium film is 2. The chassis 43 is located inside the liquid coolant flowing cavity and between the target outer shell 44 and the copper disc 41, and the chassis disc 43 is fixedly connected to the transmission shaft 6. Holes uniformly distributed in a circumferential direction of the chassis 43, the copper disc 41 and the target outer shell 44 are coaxially fixed together by threaded connection.

The back surface 413 of the copper disc 41, which is arranged away from the front surface 412, is provided with water inlet grooves 411 radially and uniformly distributed in a radial direction, in order to improve the cooling effect. A liquid inlet end of each of the water inlet grooves 411 is a central hole of the copper disc 41, and a liquid outlet end of the water inlet groove 411 is located at a position in an inner ring of an annular band where the beam 0 bombards the copper disc 41. That is, in a rotation axis of the copper disc 41, the liquid outlet end of the water inlet groove 411 is located at an annular inner ring formed by the beam 0 bombarding the copper disc 41. A side of the chassis 43 opposite to the back surface 413, is provided with an annular jet ring 42, an outer end of the annular jet ring 42 is hermetically connected to an outer end of the chassis 43, an outer end surface of an inner end of the annular jet ring 42 is provided with a supporting projection hermetically connected to the back surface 413. The annular jet ring 42 is provided with multiple jet holes 421 centered at a rotation center of the copper disc 41 and uniformly distributed in a circumferential direction. Outlet ends of the jet holes 421 directly face the back surface 413, and the jet holes 421 arranged annularly directly face a position in the annular band where the beam 0 bombards the copper disc 41. That is, cooling water passing through the jet holes 421 directly faces the annular band where the beam 0 bombards the copper disc 41, thereby realizing effective heat dissipation of the copper disc 41. A side of the chassis 43 arranged away from the copper disc 41, is provided with backwater grooves 431 radially and uniformly distributed in the radial direction. A liquid inlet end of each of the backwater grooves 431 is located at an outer edge of the chassis 43, a liquid inlet cavity is formed between the copper disc 41 and the chassis 43, and a liquid return cavity is formed between the chassis 43 and the target outer shell 44.

The solid target 4 is arranged inside the chamber 3 without contacting the housing, and a jet layer is located between the copper disk 41 and the chassis 43. The jet holes 421 are uniformly distributed in the circumferential direction at the position where the beam 0 bombards the solid target 4, and the diameter of each of the jet holes 421 is 1 mm to 2 mm. The liquid inlet end of the backwater groove 431 is located at the outer edge of the chassis 43, with the tail end of the backwater grooves 431 not going beyond an outer edge of a central hole convex flange 433 of the chassis 43. An outer edge of the target outer shell 44 is fixed to the copper disk 41 through threaded connection, and the target outer shell 44 is attached to the chassis 43.

Further, the device for continuously generating high-intensity neutrons further includes a solid target cooling device. The solid target cooling device includes a first water pipe 61 and a second water pipe 62 sleeved on an outer side of the first water pipe 61. A cavity between the first water pipe 61 and the second water pipe 62 is connected to the liquid inlet cavity, an inner cavity of the first water pipe 61 is connected to the liquid return cavity, and the first water pipe 61 and the second water pipe 62 constitute the transmission shaft 6. The first water pipe 61 is coaxially attached to the central hole convex flange 433 of the chassis 43. The second water pipe 62 is fixed to an outer side convex flange 432 of the chassis 43 through threaded connection, and the first water pipe 61 and the second water pipe 62 are coaxial with each other.

Specifically, the central hole convex flange 433 of the chassis 43 is attached to an end face of the first water pipe 61. A threaded hole is provided at an end of the outer side convex flange 432 of the chassis 43 to be connected to an end face of the second water pipe 62 through threaded connection, and an external thread is formed on an outer wall of the outer side convex flange 432 of the chassis 43 to be connected to and cooperate with an internal thread on an inner wall of a central hole of the copper disc 41. A cylinder wall of the outer side convex flange 432 of the chassis 43 is provided with holes, and the holes are in communication with the water inlet grooves 411 of the copper disc 41.

The cooling path of the solid target 4 includes: a region between the first water pipe 61 and the second water pipe 62, a region enclosed by the water inlet grooves 411 and the chassis 43 and constituting a water inlet region, a region enclosed by the first water pipe 61, and a region enclosed by the backwater grooves 431 and the target outer shell 44 and constituting a backwater region. The first water pipe 61 and the second water pipe 62 are connected to a rotating joint 9 at the same time. The cooling water enters the following positions in sequences: the region between the first water pipe 61 and the second water pipe 62, the annular cavity between the outer side convex 432 and the central hole convex flange 433 of the chassis 43, the region enclosed by the water inlet grooves 411 and the chassis 43 through the holes in the periphery of the outer side convex flange 432 of the chassis 43, the region enclosed by the jet layer and the chassis 43, the region enclosed by the copper disc 41 and the jet holes 421. The cooling water acts on an a reverse surface with respect to an active surface of the beam 0, bombarded by the beam 0, of the copper disc 41, so as to cool the copper disc 41. The water bypasses an outer edge structure of the chassis 43 from the region enclosed by the copper disc 41 and jet streams, enters the region enclosed by the backwater grooves of the chassis 43 and the target outer shell 44, then enters the first water pipe 61 of the transmission shaft 6 through an inner cavity of the central hole convex flange 433 of the chassis 43, and then is discharged through the rotating joint 9.

According to the present application, the cooling method for the solid target 4 is realized by coupling fine channels and array jet streams, with the fine channels enclosed by the water inlet grooves 411 and the chassis 43, and the array jet streams realized by the jet holes 421, thereby solving the problem of insufficient strength when a ultra-thin structure rotates at a high speed and only array jet streams are used, and solving processing and assembling problems when only the fine channels are used.

The array jet streams realized by the jet holes 421 couples a strong shear flow field formed by the high-speed rotation of the solid target 4, which forms a boundary layer thinning effect, thereby greatly improving the heat exchange efficiency. The fine channel structure realized by the water inlet grooves 411 can also greatly improve the heat exchange efficiency by increasing a heat exchange area and reconstructing a boundary layer effect. In addition, the fine channel structure realized by the water inlet grooves 411 performs structural support for the solid target 4 while dissipating heat, to relieve an impact force of the array jet streams on the solid target 4. A dual mode coupling structure of the fine channels and the array jet streams is used to cool the solid target 4, thus the heat exchange system is greatly improved, and a normal operating temperature of the solid target 4 is ensured. The transmission shaft 6 is constituted by the first water pipe 61 and the second water pipe 62, with the first water pipe 61 coaxially attached to the central hole convex flange 433 and the second water pipe 62 fixed to an outer side convex flange 432 through threaded connection. Besides, the dual mode coupling structure of the fine channels and the array jet streams is employed inside the solid target 4 to cool a region bombarded by the beam 0, and the fine channel structure performs structural support for a target piece while dissipating heat, to relieve the impact force of the array jet streams on the target piece. The fine channel structure couples an array jet stream structure, to greatly improve the heat exchange efficiency, and ensure the normal operating temperature of the solid target 4.

Based on the above solutions, preferably, the linear target tube 2 includes an electromagnet 23, a first target tube 21 and a second target tube 22 sleeved on an outer side of the first target tube 21. A flowing coolant is provided between the first target tube 21 and the second target tube 22, with the electromagnet 23 mounted at an outer side of the second target tube 22. Both the first target tube 21 and the second target tube 22 are elastic corrugated tubes which are retractable in the axial direction. The linear target tube 2 couples the beams 0 with different energy, and is axially elongated or shortened, to avoid a case that before the beam 0 enters the chamber 3, the divergence of the beam 0 occurs due to the collision with gas molecules in the linear target tube 2, resulting in an energy loss of the beam 0 and a temperature rise of a tube wall.

The linear target tube 2 is composed of an inner layer and an outer layer, and is linearly corrugated. The first target tube 21 is coaxially fitted with the second target tube 22, and the flowing coolant is filled between the first target tube 21 and the second target tube 22. The linear target tube 2 is filled with the reactive gas having a maximum pressure of 10000 Pa. The beam 0 is transmitted into the linear target tube 2 to react with the reactive gas, and meanwhile, the energy of a diverging part of the beam 0 deposited on a tube wall of the first target tube 21, is carried away by the flowing coolant between the first target tube 21 and the second target tube 22. In gases having different mass numbers, the energy attenuation of the beams 0 with different energy is different after transmission of a same distance, so as to ensure that after the reaction of the beam 0 in the linear target tube 2, the beam 0 has sufficient energy to enter the chamber 3, and is deposited and enters the solid target 4, to react with reactive materials on the solid target 4. In order to adapt to the beams 0 with different energy, the corrugated linear target tube 2 may be axially elongated or shortened as required. Accordingly, a distance between the solid target 4 and the beam 0 is adjusted, to reduce the energy attenuation of the beam 0, so as to maximize the reaction rates of the beam 0 and the reactive materials.

The electromagnet 23 is coupled to an exterior of the linear target tube 2, to focus and constrain the charged beam 0 in the linear target tube 2, so as to ensure the effective transmission of the beam 0. The position of the electromagnet 23 with respect to the linear target tube 2 is arranged to ensure the condition that the beam 0 can still focus to enter the chamber 3 after entering the linear target tube 2 and then colliding with the reactive materials, and the position is determined by calculation based on an envelope of the beam 0.

The above embodiments in this specification are described in a progressive manner. Each of these embodiments is mainly focused on describing its differences from other embodiments, and one may refer to the descriptions of other embodiments with respect to the same or similar portions.

Those skilled in the art can carry out or use the present disclosure based on the above description of the disclosed embodiments, and make many modifications to these embodiments. The general principles defined herein may be applied to other embodiments without departing from the spirit or scope of present disclosure. Therefore, the present disclosure is not limited to embodiments illustrated herein, but should be defined by the broadest scope consistent with principles and novel features disclosed herein.

1. A device for continuously generating high-intensity neutrons, comprising: a differential vacuum system, a throttle pipe, a linear target tube and a solid target device arranged in sequence along a moving direction of a beam, wherein the beam and a gaseous medium react in the linear target tube, the beam and a solid medium react in the solid target device, and two ends of an inner cavity of the linear target tube are hermetically connected to the throttle pipe and a chamber of the solid target device, respectively.

2. The device for continuously generating high-intensity neutrons according to claim 1, wherein the differential vacuum system comprises a mechanical pump, an exhaust pipe and exhaust chambers in communication with the exhaust pipe, the number of the exhaust chambers is at least two, each of the exhaust chambers is connected to at least one vacuum pump assembly, and gas outlet ends of a plurality of the vacuum pump assemblies are connected to a gas inlet end of the mechanical pump.

3. The device for continuously generating high-intensity neutrons according to claim 2, wherein the differential vacuum system further comprises a purification device mounted at an outlet end of the mechanical pump, an outlet end of the purification device is in communication with the chamber of the solid target device through a gas delivery pipe, and the vacuum pump assembly comprises a roots pump, a molecular pump, a molecular booster pump and a low-temperature pump connected in sequence along a gas flowing direction.

4. The device for continuously generating high-intensity neutrons according to claim 1, wherein the solid target device comprises a housing, a solid target, a magnetic fluid dynamic sealing component, a transmission shaft and a rotor driving device for driving the transmission shaft to rotate, the solid target is arranged in the housing, the chamber is formed between an outer side of the solid target and the housing, the transmission shaft is fixedly connected to the solid target; the magnetic fluid dynamic sealing component comprises a magnetic fluid dynamic sealing inner shell coaxially fitted with the outer diameter of the transmission shaft and a magnetic fluid dynamic sealing outer shell arranged coaxially with the solid target and detachably connected to the housing, and the magnetic fluid dynamic sealing outer shell covers an outer side of the magnetic fluid dynamic sealing inner shell; the housing is mounted at a tail end of the linear target tube in the moving direction of the beam, and the linear target tube directly faces the solid target.

5. The device for continuously generating high-intensity neutrons according to claim 4, wherein in a projection in a direction of a rotation axis of the solid target, a distance between the tail end of the linear target tube in the moving direction of the beam and a rotation center of the solid target is greater than zero.

6. The device for continuously generating high-intensity neutrons according to claim 4, wherein the solid target comprises a target outer shell, a copper disc and a chassis, with the target outer shell and the copper disc each fixedly connected to the chassis, the copper disc and the target outer shell constituting an inner cavity to form a liquid coolant flowing cavity, a front surface of the copper disc directly facing the tail end of the linear target tube, a titanium film deposited on the front surface of the copper disc, the chassis arranged inside the liquid coolant flowing cavity and between the target outer shell and the copper disc, and the chassis fixedly connected to the transmission shaft.

7. The device for continuously generating high-intensity neutrons according to claim 6, wherein a back surface of the copper disc being away from the front surface is provided with water inlet grooves radially and uniformly distributed in a radial direction, the liquid inlet end of each of the water inlet grooves is a central hole of the copper disc, a liquid outlet end of each of the water inlet grooves is located at a position in an inner ring of an annular band where the beam bombards the copper disc, a side of the chassis opposite to the back surface is provided with an annular jet ring, an outer end of the annular jet ring is hermetically connected to an outer end of the chassis, an outer end face of an inner end of the annular jet ring is provided with a supporting projection hermetically connected to the back surface, the annular jet ring is provided with a plurality of jet holes centered at a rotation axis of the copper disc and uniformly distributed in a circumferential direction, outlet ends of the jet holes directly face the back surface, and the jet holes arranged annularly directly face a position in the annular band where the beam bombards the copper disc, a side of the chassis arranged away from the copper disc, is provided with backwater grooves radially and uniformly distributed in the radial direction, a liquid inlet end of each of the backwater grooves is at an outer edge of the chassis, a liquid inlet cavity is formed between the copper disc and the chassis, a liquid return cavity is formed between the chassis and the target outer shell, and the liquid inlet cavity is in communication with the liquid return cavity through the jet holes.

8. The device for continuously generating high-intensity neutrons according to claim 7, further comprising a solid target cooling device, wherein the solid target cooling device comprises a first water pipe and a second water pipe sleeved on an outer side of the first water pipe, a cavity between the first water pipe and the second water pipe is connected to the liquid inlet cavity, an inner cavity of the first water pipe is connected to the liquid return cavity, and the first water pipe and the second water pipe constitute the transmission shaft.

9. The device for continuously generating high-intensity neutrons according to claim 7, wherein a central hole convex flange of the chassis is attached to an end face of the first water pipe, a threaded hole is provided at an end of an outer side convex flange of the chassis to be connected to an end face of the second water pipe through threaded connection, and an external thread is formed on an outer wall of the outer side convex flange of the chassis to be connected to and cooperate with an internal thread on an inner wall of a central hole of the copper disc, a cylinder wall of the outer side convex flange of the chassis is provided with holes, and the holes are in communication with the water inlet grooves.

10. The device for continuously generating high-intensity neutrons according to claim 1, wherein the linear target tube comprises an electromagnet, a first target tube and a second target tube sleeved on an outer side of the first target tube, a flowing coolant is provided between the first target tube and the second target tube, the electromagnet is mounted at an outer side of the second target tube, and both the first target tube and the second target tube are elastic corrugated tubes which are retractable in an axial direction.
